(19) United States
(12) Patent Application Publication
(10) Pub. No.: US 2017/0287249 A1
(43) Pub. Date: Oct. 5, 2017

(54) ARTIST AND CHARITY VOTING PLATFORM

(71) Applicants: Ebrahim Beigi-Nejad Maghsoud, Daphne, AL (US); Zan Ng, Cos Cob, CT (US)

(72) Inventors: Ebrahim Beigi-Nejad Maghsoud, Daphne, AL (US); Zan Ng, Cos Cob, CT (US)

(21) Appl. No.: 15/480,160

(22) Filed: Apr. 5, 2017

Related U.S. Application Data
(60) Provisional application No. 62/318,466, filed on Apr. 5, 2016.

(51) Int. Cl. G07C 13/00; G06K 7/14; G06Q 30/02

(52) U.S. Cl. CPC G07C 13/00; G06Q 30/0222; G06Q 30/0212; G06Q 30/0214; G06K 7/1417

(57) ABSTRACT

The present invention provides a system for selecting Artists and Charities by allowing purchasers in a commercial setting to vote for the Artists and Charities of their choice.

### FIELD OF THE INVENTION

The present invention relates to a cross device functional platform that unifies Art, Charity, and Commerce with a Voting Mechanism designed to engage local communities, which we call NextNext. The core function of NextNext unifies the profiles of Musicians, Fine Artists, Filmmakers, Writers, etc. (hereafter referred to as Artists) and Charities with voting mechanics that allow users to apply votes that are earned through purchases with a commercial entity to select Artists and the Charities that they support.

### BACKGROUND OF THE INVENTION

The need for this invention arose from the fact that national and international commercial entities have few systematic methods through which to gain local engagement with consumers. With the present invention, Commercial Entities are given a means and method through which User Generated Content (Music/Art/Film/Writing, etc.), can create organic engagement with local consumers, and transform retail spaces into centers for community activity.

The present invention includes an apparatus for unifying Artists profiles and Charities profiles within a defined system tied to commercial transactions. While systems may exist for benefiting either Artist or Charities, we can find no precedent of a system unifying both distinct groups.

### SUMMARY OF THE INVENTION

In accordance with the present invention, the inventors of the present invention have developed a system that unifies the goals of Artists, Charities, and Commercial Entities in a system that creates mutual benefit for all parties involved.

Specifically, this system creates an automated link between Artists and Charities registered within the database. When registering within the system, Artists can chose from a listing of registered Charities to partner with throughout the duration of a promotion or contest. Once a Charity has been selected by an Artist a link is created between the two in the inventions database that unites the profiles through a variety of integrated functions. See FIG. 1.

This unification includes UI output in both native and web applications, and also a shared bank of votes earned through tokens distributed at point of sale. Within the UI, output includes total votes accumulated for Artists and Charities, as well as standings for specific contest or promotion. Cross linkage inside of profiles increases exposure for both participating Artists and Charities. See FIG. 2 for an example of what a purchaser would see on a smart phone of the cross linkage of the Artist and the charity that the Artist supports, and the cross linkage of the charity and the Artists that support that charity.

The Inventions voting system is tied directly to point of purchase, and vote points can be earned according to purchase value online or offline, through integration at retail locations. In the case of beta promotion, votes were distributed at point of sale in the form of vote cards that featured a QR Code that were scanned directly into the system. After unlocking vote points, users apply earned vote to the Artists of their choice. The Charity that the Artist has elected to support earns benefits from each vote point earned. See FIG. 3 for a schematic flowchart of the voting system. See FIG. 4 for an example of the use of a smart phone to scan the QR Codes from the vote cards.

Vote tokens are generated through the system database, and upon activation are tracked within the backend of the system, allowing for the output of both top level and granular data on total transactional value of any promotion run through the invention apparatus. See FIG. 5 for a schematic of the system architecture that can be used as one embodiment of the invention.

As no system was previously known that unifies Artists and Charity profiles, the novelty and major advantage of the system also extends to the voting apparatus. Specifically, we find no precedent for a point of sale (relative to value of purchase) that can be applied through a system to unlock votes for Artists and the Charities that the Artists support.

The major economic advantages of this system for commercial entities will be that commercial entities choosing to operate the NextNext system will have immediate access to a promotional apparatus and methodology that creates organic user generated material relevant to a local community or market. Depending on how the system is applied, this can act in a transformative fashion, transforming retail locations into epicenters for local Art, Charity, and community engagement.

### BRIEF DESCRIPTION OF DRAWINGS

FIG. 1 schematically shows the linking within the database of the Artist Profile that is inputted by the Artist during registration with the Charity Profile that is inputted by the Charity during its registration.

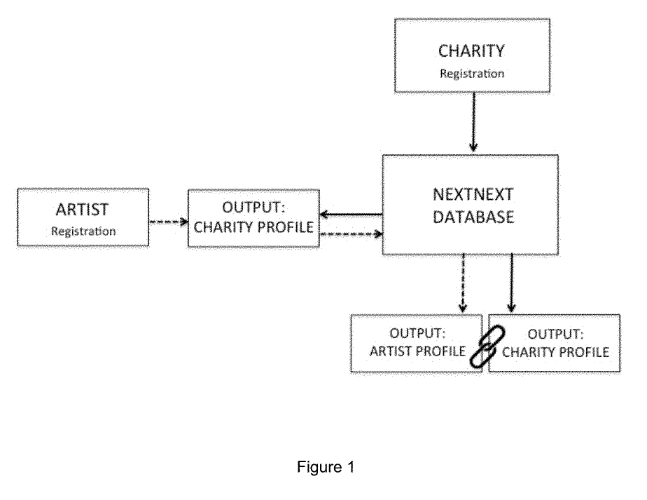

FIG. 2 shows displays on a smart phone of the cross linkage of the Artist and the charity that the Artist supports, and the cross linkage of the charity and the Artists that support that charity.

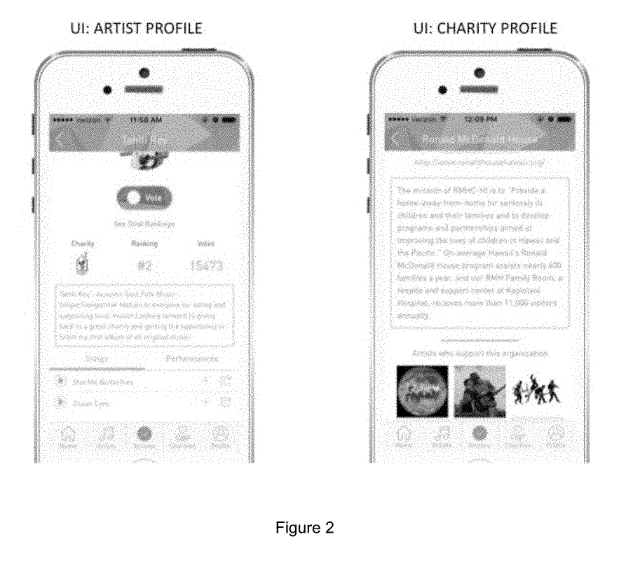

FIG. 3 shows flowchart of how a fan/voter can vote for an Artist of his choice after completing a purchase at a commercial entity.

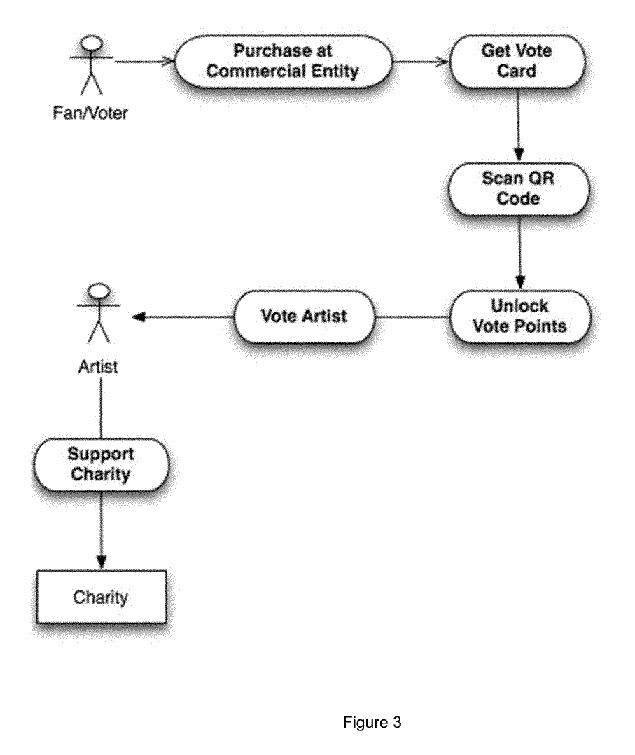

FIG. 4 shows an example of the use of a smart phone to scan the QR Codes from the vote cards.

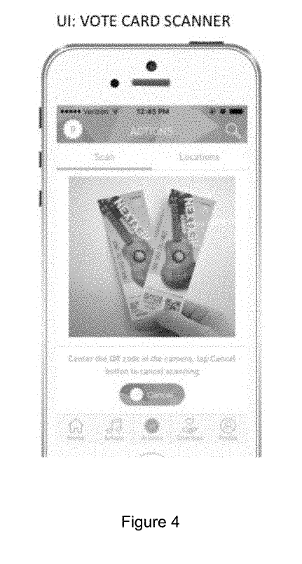

FIG. 5: shows a schematic of the system architecture that can be used as one embodiment of the invention.

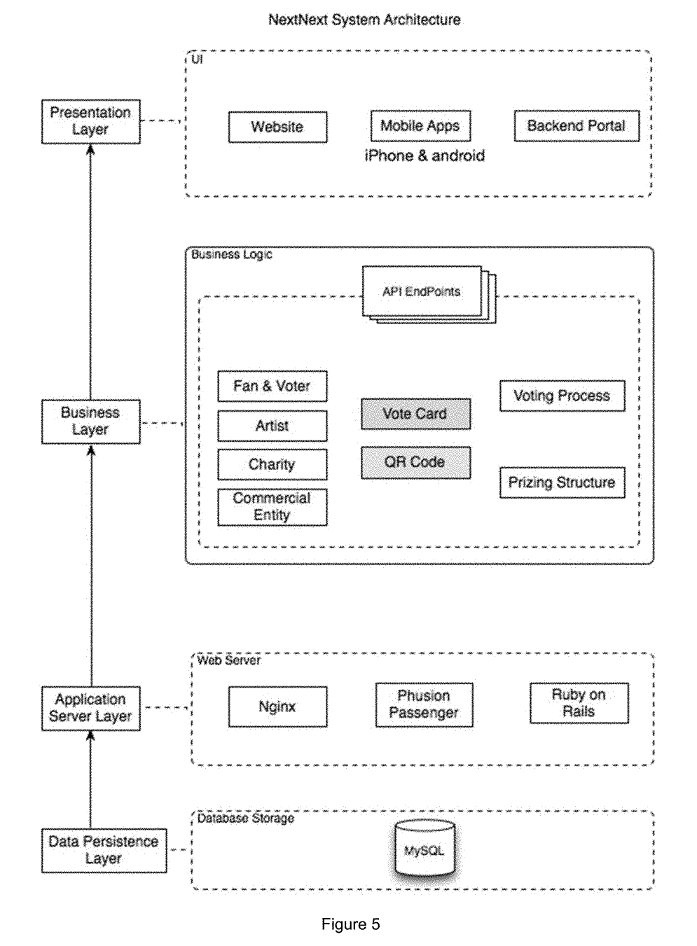

### DETAILED DESCRIPTION OF THE PRESENTLY PREFERRED EMBODIMENTS

Accordingly, the present invention is directed to a platform made up of several key components within an ecosystem that works towards creating mutual benefit for all involved parties, this includes:

Submission Portal

An open portal through which Artists and Charities can create accounts and profiles to showcase their Art or their Cause.
Charities may, upload profile pictures, organization data, and event information
Artist may, upload their Art, including music or fine art, upload profile picture, Artists data, and event information
User profiles—Profiles of Users (Voters) are created to utilize the various functions of the present inventive apparatus, including, most prominently applying votes to Artists and associated Charities.

Profile Unification

Artists, upon creation of a profile, must chose, from a list of pre-approved Charities, a Charity to support. Once this is completed, the Artist and Charity profiles are linked throughout the duration of a specific “promotion period”. Multiple Artists can support a single Charity.

Voting Process

Over the course of a promotional period, Users, when completing a purchase at a participating Commercial Entity, will receive Vote Cards relative to the value of their total purchase. A Vote card, which may be integrated into Point-of-Sales systems, includes a QR or code. When this code is input into the platform it will unlock votes, which can then be applied to an Artist, and in turn the charity that the Artist supports. Optionally, when the votes are exhausted, the User is directed to the same or other participating Commercial Entity to complete additional purchases to thereby receive additional Vote Cards.

Backend Tracking

The system can track the following information per profile type.
For Artists: Total Votes received within System
For Charities: Total Votes received from associated Artists
For Users: Total Votes completed by an individual voter
For Commercial Entities: Origin location of redeemed Vote Card(s) and Quantified ROI per location

Frontend Output:

The output of the system for Users includes:
Charts for Artists/Charities receiving the most votes
Favorite features to track progress of Artist for which a user had previously voted
Push notifications tied to progress of Artist for which a user had previously voted

Prizing Structure:
Utilizing the backend data generated from the system, participating Commercial Entities may apply rewards or prizes to the top performing Artist, Charities, or Users according to the legal restrictions of their specific market.

In one embodiment, the Artists are selected by members of a local community where the Commercial Entity is located.

We claim:

1. A system for a purchaser to select Artists and Charities comprising
a) a portal to upload into a database the profiles of the Artists and Charities, the Artists' Art, and the charity each of the artists supports;
b) a portal for a purchaser of an item at a commercial entity to access the database of a), and to obtain a number of Vote Cards based on the value of the item purchased;
c) a portal for the purchaser to use the Vote Cards to vote for an Artist based on the Art; and
d) a database to store the number of votes to each of the Artists.

2. The system of claim 1, wherein the profile of the Artist and the profile of the charity the Artist supports are linked in the database; and the profile of the Artist and the profile of the linked charity are jointly made accessible to a purchaser.

3. The system of claim 1, wherein the portals and b) and c) allow the purchaser to: i) obtain a number of Vote Cards having a QR Code; ii) scan the QR Codes to unlock Vote Points, and iii) vote for an Artist based on the unlocked Vote Points.

4. The system of claim 1 where the Artist who has the most votes in a predetermined period will receive a prize.

5. The system of claim 1 where the Charity selected by the Artist who has the most votes in a predetermined period will receive a prize.

6. The system of claim 1 which further comprises a database containing the profile of the purchaser comprising the number of Vote Cards used by the purchaser, and which commercial entity the Vote Cards were obtained.

7. The system of claim 1 where the portal of a) restricts the upload of profiles of Artists that are located in a predetermined community.

8. The system of claim 1 where the database of a) restricts the purchaser to use the Vote Cards to vote for Artists that are located in a predetermined community.
